(19) United States
(12) Patent Application Publication
(10) Pub. No.: US 2009/0088485 A1
(43) Pub. Date: Apr. 2, 2009

(54) Method for controlling foaming in a process

(76) Inventors: Menno Anton Van Dijk, Amsterdam (NL); Wouter Koot, Amsterdam (NL); Albert Jan Zeeman, Amsterdam (NL)

Correspondence Address: SHELL OIL COMPANY, P O BOX 2463, HOUSTON, TX, 772522463, US

(21) Appl. No.: 11/988,976

(22) PCT Filed: Jul. 13, 2006
(86) PCT No.: PCT/EP2006/064246

§ 371 Date: Jan. 17, 2008

(30) Foreign Application Priority Data
Jul. 21, 2005 (EP) 05106707.2

(51) Int. Cl. B01D 19/02; G01N 21/00

(52) U.S. Cl. 516/115; 356/436

(57) ABSTRACT

The invention is a method for controlling foaming in a process, the method comprising the steps of: (a) withdrawing process liquid from the process and generating gas bubbles in the process liquid by contacting the process liquid with bubble gas; (b) measuring individual lifetimes of the gas bubbles to obtain bubble lifetime data; (c) using the bubble lifetime data to predict the foam-forming tendency of the process liquid; (d) if the bubble lifetime data indicate that excess foaming will occur, adjusting the process to prevent excess foaming.

The invention relates to a method for controlling foaming in a process.

The invention also relates to an in-line early warning method to prevent excess foam formation in a liquid.

Foaming is a known phenomenon in industrial processes and need not cause problems when the degree of foaming is relatively low. However, excess foaming in industrial processes can lead to overflow of liquid. Thus, excess foaming is generally unwanted and needs to be prevented or suppressed. Especially in refinery processes, formation of excess foam can give rise to serious operational problems and malfunctioning. Excess foaming often occurs as a result of a change in composition of a process liquid or a change in the conditions to which the process liquid is subjected.

An example is a so-called gas treating process, a process in which acidic contaminants are removed from a gas stream, often by contacting the gas stream with an amine liquid in an absorber. In the gas-treating process, contaminants are transferred from the gas stream to the liquid, resulting in a loaded liquid comprising contaminants. The loaded liquid will be more prone to excess foaming due to the presence of contaminants. Excess foaming of (loaded) amine liquid will an overflow of liquid out of the absorber, resulting in major problems.

Another example where unwanted excess foaming can occur is the pumping of crude oil from one vessel into another. Crude oil often comprises contaminants, which can cause foaming. Due to lowering of the pressure, excess foaming can occur and oil can spill from the vessel.

In the art, various methods have been described to assess foam formation in a process. Generally, the known methods are based on measuring the stability of foam or the height of a foam layer.

For example, a method for evaluating foamability in a liquid is described in U.S. Pat. No. 3,739,795. The method described in U.S. Pat. No. 3,739,795 is based on synthetically causing foaming in a split stream taken from the liquid and evaluating the foamability through conductivity measurements.

A disadvantage of the device and method described in U.S. Pat. No. 3,739,795 is that foam needs to be generated in order to perform the measurement. This results in a time-consuming method. In addition, the method is not suitable for liquids normally having a low tendency to foam formation, as the generation of foam in such liquids would be difficult.

Another disadvantage of the method mentioned in U.S. Pat. No. 3,739,795 is that the liquid needs to have a certain degree of conductivity, because the method is based on conductivity measurements. This renders the method unsuitable for process liquids lacking the required degree of conductivity. Furthermore, conductivity measurements are sensitive to contaminants having a certain degree of conductivity, which can be present in a process. Yet another disadvantage is that deposits of contaminants on conductivity probes will results in a need for frequent periodic cleaning of these probes.

Another method and device are described in DE 19,736,679. The method applied in DE 19,736,679 relies on ultrasonic measurements to measure average foam height. The foam bubble diameter is measured using a high-speed camera. The method described in DE 19,736,679 also has the disadvantage that foam needs to be formed first in order to perform the measurement, resulting in a time-consuming method.

There is therefore a need for a simple and versatile method to assess and control foaming in a process, especially in an industrial process where foaming is unwanted and could lead to operational problems.

To this end, the invention provides a method for controlling foaming in a process, the method comprising the steps of:

(a) withdrawing process liquid from the process and generating gas bubbles in the process liquid by contacting the process liquid with bubble gas;
(b) measuring individual lifetimes of the gas bubbles to obtain bubble lifetime data;
(c) using the bubble lifetime data to predict the foam-forming tendency of the process liquid;
(d) if the bubble lifetime data indicate that excess foaming will occur, adjusting the process to prevent excess foaming.

The method according to the invention offers a relatively simple and quick way to control foaming in a process. Because foaming tendency is evaluated through bubble lifetime data, there is no need for synthetically forming foam. Thus, the occurrence of excess foaming can be predicted at an early stage and controlling of foaming will thus be facilitated.

Another advantage is that foaming can be evaluated and controlled even in a process normally having a low foaming tendency under certain process conditions but giving rise to unwanted excess foaming when a change in process conditions takes place. Because the method according to the invention offers the possibility to evaluate foaming tendency without having to generate foam, foaming tendency can be assessed even in processes normally having low foam-forming tendency and foaming can be controlled in the process.

Yet another advantage of the method according to the invention is that evaporation of volatile components in the process liquid will be much less. The known methods to control foaming all involve the creation of foam. To generate foam in a liquid, bubbles are usually sparged into the liquid at high speed, thereby facilitating evaporation of volatile components in the liquid. The method according to the invention does not involve the generation of foam. Evaporation of volatile components is thereby considerably less. This enables a better imitation of the process conditions because the composition of the process liquid does not change significantly during the measurement. Furthermore, assessment of the foaming tendency will be more accurate because the method is not influenced by changes in process liquid composition.

The method according to the invention can be applied to any process which can be subject to excess foaming. The method is especially suitable for so-called gas-treating processes in the oil industry. Gas-treating processes are aimed at removing contaminants, especially sulphur contaminants, by transferring them from a gas stream to a liquid in order to purify the gas stream. As a result of this transfer, a loaded liquid comprising contaminants is obtained.

Typically, in a gas-treating process the process parameters are chosen such that the contact between the gas stream to be purified and the liquid is as high as possible in order to promote transfer of contaminants from the gas stream to the liquid. However, this results in an increased tendency to excess foaming. Therefore, in process liquids derived from gas treating processes foaming problems often occur and can result in serious operational problems.

Common sulphur contaminants are H2S, COS, CS2 and RSH. Other contaminants which can be present include higher hydrocarbons (present in natural gas streams), lubrication oil, finely divided suspended solids, surface-active agents and degradation products of the liquid. The amount of contaminants in the gas streams to be purified can vary, resulting in a varying concentration of these contaminants in the process liquid. It is believed that this varying concentration of contaminants can give rise to the occurrence of excess foaming.

Foaming is especially troublesome when the process liquid, especially a process liquid in a gas-treating process, comprises an aqueous amine solution, especially an aqueous solution of one or more compounds from the group of mono-ethanolamine, di-ethanolamine and tri-ethanolamine. Such amine-comprising liquids generally display a tendency for foaming, even more so in the presence of contaminants. In amine solutions, degradation products of the amine compounds can contaminate the solution and cause foaming. In the presence of oxygen, a reaction between oxygen and amines can take place to form formic acids, glycolic acids and oxalic acids. The ions of these acids form heat stable salts, which contaminate the amine solution and can cause foaming. The method according to the invention offers a simple and quick way to evaluate the foaming tendency of process liquids involving the removal of contaminants from a gas stream using an aqueous amine solution.

The method according to the invention is also suitable for a process liquid comprising crude oil. Crude oil on its own has a low tendency for foaming. However, usually a small or a more substantial amount of gas is dissolved in crude oil. The amount of dissolved gas varies and can be in the range of from 0.01 volume % up to several volume percents. In addition, small amounts of surface-active agents may be present in crude oil, for example as a result from the exploration process in order to obtain crude oil. These surface-active agents can promote foaming. When the conditions to which a liquid comprising crude oil is subjected are changed in such a way that the gas separates from the liquid, excess foaming can occur, especially in the presence of (small) amounts of surface-active agents.

An example of such a condition is a change in pressure. At elevated pressures, the gas usually stays dissolved in the crude oil and little or no foaming occurs. Foaming especially occurs when a process liquid comprising crude oil is subjected to a decrease in pressure, for example when the process liquid is transferred from one vessel to another. Typically, the decrease in pressure is between 5 and 100 bar, preferably between 10 and 50 bar. The decrease in pressure releases an amount of gas sufficient to cause foaming.

The process according to the invention enables assessment and control of foaming in a crude oil liquid. Because there is no need to generate foam, the foaming tendency of a process liquid comprising crude oil can be evaluated using the method according to the invention in a quick and simple way. This enables an assessment of whether or not excess foaming is likely to take place, for example when transferring the process liquid comprising crude oil from one vessel to another.

In step (a) of the method according to the invention, process liquid is withdrawn and a gas bubble is generated in this process liquid by contacting the process liquid with bubble gas. It will be understood that the process liquid may still comprise small amounts of gas, for example gaseous components. In a gas-treating process, typically these gaseous components will be the contaminants removed from the gas stream. Withdrawing process liquid from the process can involve, if necessary, a bulk separation of a process fluid into a gas phase and a liquid phase.

Preferably, only a relatively small part, preferably at most 500 milliliters, more preferably at most 100 milliliters, of the process liquid is withdrawn. It will be understood that in an industrial process, these small amounts are negligible compared to the total amount of process liquid. By withdrawing only a relatively small part of the total process liquid, the bulk process liquid will be almost undiminished and the process is not affected by the method. Suitably, the process liquid is taken from a gas/liquid contactor or from a gas/liquid separator. The type of gas/liquid contactor or separator is not critical to the invention.

Preferably, the bubble gas is introduced into the process liquid in a controlled way. For example, a controlled valve can be used, whereby small quantities of the bubble gas at a time are pumped or pressed into the narrow tube until a bubble has formed. Typically, the small quantities of bubble gas are in the range of from 0.05 to 0.5 of the volume of the resulting bubble, preferably in the range of from 0.1 and 0.3 of the volume of the resulting gas bubble. By applying these small quantities, the controlled formation of one bubble at a time is ensured while at the same time a single bubble can be generated in a sufficiently short time.

The pumping or pressing can be done either continuously or discontinuously. When the pumping or pressing is done continuously, the small quantities of gas are pumped or pressed into the narrow tube continuously until a bubble is formed. In a preferred embodiment, the pumping or pressing is done discontinuously, allowing each small quantity of gas to reach the top of the narrow tube before the next quantity of gas is pumped or pressed into the narrow tube. The combined quantities of gas will together form the bubble at the gas/liquid interface. When applying discontinuous pumping, it is easier to control the formation of only one bubble. Moreover, the pumping can be easily stopped and continued as the need arises.

The bubble gas used to generate the bubble can be an inert gas, for example nitrogen or helium. Preferably, the gas is taken from a gas stream from some point in the process. If the process is a gas-treating process, the bubble gas can be taken from the gas stream comprising contaminants via a small split stream. Using this gas stream has the advantage of an even more close simulation in the measuring cell of the actual conditions in the process. This enables an even better way to assess foaming tendency and to control foaming in the process.

A preferred device for generating a gas bubble comprises a measuring cell, a narrow tube positioned inside the measuring cell and a pump connected to the narrow tube. In the measuring cell, a gas/liquid interface is present. Generally, the gas/liquid interface will be oriented horizontally. The gas phase of the gas/liquid interface is preferably formed by air but may also be formed by the gas used to generate the bubbles. It will be understood that the liquid phase in the measuring cell comprises the process liquid.

In the measuring cell, one bubble at a time is generated at the gas/liquid interface. The pumping or pressing is stopped when one bubble is detected.

Suitably, the gas is introduced via a narrow tube, preferably a capillary tube, positioned inside the measuring cell. Preferably, the diameter of the narrow tube is in the range of from 0.01 to 0.5, more preferably from 0.01 to 0.1 of the diameter or width of the measuring cell. Gas is made to flow through this narrow tube and reaches the gas/liquid interface. By using a narrow tube, the controlled generation of one bubble is facilitated, since the flow of gas through the tube will be slower and therefore more controlled. Suitably, the top of the narrow tube is positioned below the gas/liquid interface, to enable the passage of a gas bubble to the gas/liquid interface.

It will be understood that more than one tube can be used. For example, a number of narrow tubes arranged in a parallel alignment with respect to each other can be employed, each tube being connected to a means for introducing gas into the tube. By allowing one bubble to emerge from each tube, several bubbles can be generated.

Typically, the distance between the top of the tube and the gas/liquid interface is in the range of from one bubble diameter to 10 bubble diameters, preferably from 2 bubble diameters to 5 bubble diameters.

Preferably, a pump is connected to the narrow tube to introduce bubble gas into the tube. Suitable pumps are precision pumps enabling a controlled release of small quantities of gas. A preferred pump is a syringe pump, which allows a specific volume of gas, contained in a syringe, to be emptied into the capillary tube to generate a bubble. The size of the bubble thus generated can be predetermined in an easy way, by setting the volume of the syringe to the desired value. Another advantage is that a preset number of small quantities of gas can be used because the volume of the gas in the syringe is known. This facilitates automizing the system and enables a better reproducibility. Suitably, the pump or press generates one bubble at a time by pumping or pressing small quantities of a gas into the capillary until one bubble has formed.

Although in the method according to the invention the evaporation of volatile components is very little, the measuring cell can optionally be covered, for example with a lid or with a seal, to further prevent evaporation of volatile components from the process liquid contained in the measuring cell. An additional advantage of covering the measuring cell is that the measuring device can be operated at elevated pressure and elevated temperatures. Since most processes operate at elevated pressure and temperature, when using a covered measuring cell the method can be easily integrated into the process without the need for a pressure or temperature reduction.

Preferably, the measuring cell further comprises means to establish a convex shape, seen from the perspective of the liquid, of this gas/liquid interface. One example of a suitable means for establishing a convex shape is a means to fill the measuring cell to a level such that a convex shape is obtained. Typically, a controlled valve in the inlet of the measuring cell is used, enabling a controlled flow of liquid into the measuring cell until the desired level.

Another suitable means for establishing a convex shape is by lowering the surface tension of the measuring cell walls to the extent that the surface tension of the measuring cell walls is lower than the surface tension of the liquid. Without wishing to be bound by any theory, it is believed that the difference in surface tension between the measuring cell walls and the liquid results in the liquid being driven from the measuring cell walls, resulting in a convex shape of the liquid. Lowering of the surface tension of the measuring cell walls can be achieved for example by coating the measuring cell walls with a substance which has a low surface tension. A preferred substance is Teflon, due to its proven surface tension lowering properties and durability.

The individual lifetime of the gas bubbles can be measured in many different ways.

In a first embodiment, conductivity measurements are used to measure the lifetime of the gas bubbles. In this case, conductivity probes are used, which can detect a disruption of the gas bubble. This embodiment can advantageously be employed when the process liquid has conductive properties and is relatively free of contaminants.

In a second, preferred, embodiment, the individual lifetimes of the gas bubbles are measured using light emission, for example via a device comprising a light source and a detector. In this embodiment, typically the light source emits a light beam directed towards the bubbles. A detector is positioned preferably in such a way that the detector has a maximum sensitivity to detect the light beam when no gas bubbles is present. The detector registers the disruption of the light beam caused by the gas bubble. The lifetime of the gas bubble is taken as the time during which the light beam is disrupted. Suitably, visible light or infrared light can be applied.

This embodiment offers the advantage that individual bubble lifetimes can be measured irrespective of for example the degree of conductivity of the process liquid or any other characteristic property of the process liquid. Another advantage is that the equipment is relatively easy to operate since there is no need for periodically cleaning electrodes, as is the case when using conductivity measurements. Yet another advantage is that if the process liquid comprises contaminants, for example in a gas-treating process, the measurement is not affected. Unlike for example in the case where conductivity measurements are used, the detection is not sensitive to the presence of contaminants.

In a third embodiment, ultrasonic measurements are used to measure individual lifetimes of the gas bubbles. In this embodiment, the detector typically emits ultrasonic waves directed towards the gas bubble. When the gas bubble is intact, the ultrasonic waves are disrupted. The detector detects the disruption of the ultrasonic waves and relates it to the bubble lifetime. The advantage of using ultrasonic measurements is that the measurement can be done even in very turbid systems or in systems having a low conductivity.

It will be understood that individual bubble lifetimes can vary widely, depending on the process. Typical individual bubble lifetimes are in the range of from 1 to 6000 ms.

Bubble lifetime data are used to predict the foaming tendency of the process. It will be understood that the assessment of foaming tendency based on bubble lifetime data depends inter alia on the type of process and on the composition of the process liquid.

One way to assess foaming tendency is to determine the average bubble lifetime. It is believed that a longer lifetime reflects a higher foaming tendency, since the bubbles live long enough to generate foam. Typically, an average lifetime above 2000 ms is an indication that it is expected that excess foaming will occur.

Another way to assess foaming tendency is to determine if a fraction of the bubble lifetimes is above a certain value. Generally, if a fraction in the range of from 1% to 60%, preferably from 5% to 30% of the total amount of bubbles has a lifetime above a certain value, typically in the range of from 500 to 6000 ms, are an indication that it is expected that excess foaming will occur.

Yet another way to assess foaming tendency is via the median bubble lifetime. The median bubble lifetime is the lifetime at which 50% of the bubbles life longer and 50% of the bubble life shorter. In a graph of cumulative distribution of bubble lifetimes (vertical axis) versus measured bubble lifetimes (horizontal axis), the median bubble lifetime is the bubble lifetime corresponding with a cumulative distribution of 0.5 on the vertical axis.

The way in which the process is adjusted depends on the type of process and on the process liquid. A preferred way to adjust the process involves adding a quantity of anti-foaming agent, especially where the process liquid is an aqueous liquid comprising contaminants. The addition of suitable anti-foam agents is a relatively simple way to adjust the foamability of the process liquid and can be automated. Suitable anti-foam agents are for example silicone compounds or high-boiling alcohols.

The dosage of anti-foam agent depends on the foaming tendency and should therefore be adjusted accordingly. Typically, the amount of anti-foam agent added is such that the concentration of anti-foam in the (bulk) process liquid is in the range of from 5 to 20 ppm, preferably in the range of from 10 to 15 ppm.

The invention also provides a method for evaluating the activity of an anti-foam agent in a liquid, wherein the individual lifetime of a gas bubble in the liquid is measured and the liquid in the sample cell comprises an anti-foam agent.

Another possible way to adjust the process is to remove excess contaminants, which can be the cause of excess foaming in for example a gas treating process. Contaminants can at least partly, preferably to a large extent, be removed using for example one or more extra filters or filter beds. Especially an activated carbon filter bed has been found to give satisfactory results. This method is preferred in the case where the contaminants are capable of causing further harm such as corrosion of the walls of the vessel wherein the process liquid is contained. As elaborated earlier, this phenomenon occurs especially in the treatment of gas streams using aqueous amine systems.

The invention will now be illustrated by the following, non-limiting examples.

### EXAMPLE 1

### Bubble Lifetime Distribution

Single gas bubbles were generated in a solution comprising 40% diisopropylamine, 3% acetic acid and water in a measuring cell as described hereinbefore. Gas bubbles were generated by introducing nitrogen gas in a capillary tube placed inside the measuring cell. The capillary tube was connected to a syringe pump. The individual lifetimes of the gas bubbles was measured. The cumulative distribution of the individual bubble lifetimes versus the bubble lifetime (in milliseconds) is given in FIG. 1. One way to assess foam-forming tendency is via the median bubble lifetime. The median lifetime corresponds to 0.5 on the vertical axes of a graph of cumulative bubble lifetime distribution versus bubble lifetime.

### EXAMPLE 2

### Effect of Anti-Foam Agent Concentration

Single gas bubbles were generated in a solution comprising 40% diisopropylamine, 3% acetic acid, anti-foam agent and water in a measuring cell and gas bubbles were generated by introducing nitrogen gas in a capillary tube placed inside the measuring cell. The capillary tube was connected to a syringe pump. The individual lifetimes of the gas bubbles was measured. The amount of anti-foam agent added was varied. The type of anti-foam agent was not changed. The cumulative distribution of the individual bubble lifetimes of the solutions having different concentrations of anti-foam agent versus bubble lifetime (in milliseconds) is given in FIG. 2. A decreasing bubble lifetime is observed with increased amounts of anti-foam.

### EXAMPLE 3

### Effect of Type of Anti-Foam Agent

Single gas bubbles were generated in a solution comprising 40% diisopropylamine, 3% acetic acid, anti-foam agent and water in a measuring cell as described in example 1. Bubble lifetime data were generated in four solutions, one without an anti-foam agent (A) and three solutions each comprising a different anti-foam agent, B, C and D. One way to assess foam-forming tendency is via the median bubble lifetime. The median lifetime corresponds to the bubble lifetime at 0.5 on the vertical axes of a graph of cumulative bubble lifetime distribution versus bubble lifetime (see FIGS. 1 and 2).

FIG. 3 shows the median bubble lifetime as measured in these four solutions (in milliseconds) as a function of anti-foam agent dosage (in ppm). At the median bubble lifetime, 50% of the bubbles lived longer and 50% lived shorter. The average median bubble lifetime of the amine solutions without antifoam was determined at 640 ms. FIG. 3 shows that in solutions with added anti-foam agent, the median bubble lifetime is lower. Even 1 ppm of added anti-foam agent results in a significant lowering of median bubble lifetime. FIG. 2 also shows that addition of anti-foam agent B results in the lowest median bubble lifetime.

1. A method for controlling foaming in a process, the method comprising the steps of:
(a) withdrawing process liquid from the process and generating gas bubbles in the process liquid by contacting the process liquid with bubble gas;
(b) measuring individual lifetimes of the gas bubbles to obtain bubble lifetime data;
(c) using the bubble lifetime data to predict the foam-forming tendency of the process liquid;
(d) if the bubble lifetime data indicate that excess foaming will occur, adjusting the process to prevent excess foaming.

2. A method according to claim 1, wherein the gas bubbles in step (a) are generated by
(a1) leading withdrawn process liquid into a measuring cell, so that the measuring cell comprises a liquid phase and a gas phase with a gas/liquid interface;
(a2) introducing bubble gas into the measuring cell to generate gas bubbles at the gas/liquid interface.

3. A method according to claim 2, wherein the bubble gas is derived from the process.

4. A method according to claim 3, wherein the difference between the pressure and/or temperature in the measuring cell and the operating pressure and/or temperature of the process is less than 10%.

5. A method according to claim 4, wherein the gas bubbles are generated by pumping or pressing a small quantity of bubble gas into a capillary, said capillary being positioned inside the measuring cell.

6. A method according to claim 5, wherein the individual lifetimes of the gas bubbles are measured using an emitter, a detector and a processor, wherein the emitter emits a light beam directed towards the one or more bubbles, the detector registers the disruption of the light beam and wherein the bubble lifetime is taken as the time during which the light beam is disrupted.

7. A method according to claim 6, wherein the process is a gas treating process wherein a gas stream comprising contaminants is contacted with a liquid, thereby transferring at least part of the contaminants from the gas stream to the liquid to obtain the process liquid.

8. A method according to claim 7, wherein the contaminants in the gas stream are one or more sulphur compounds selected from the group consisting of H₂S, COS, CS₂ and RSH.

9. A method according to claim 8, wherein the process liquid comprises an aqueous amine solution.

10. A method according to claim 9, wherein adjusting the process in step (d) involves adding a quantity of anti-foaming agent.

11. A method according to claim 6, wherein the process liquid is obtained by subjecting a liquid comprising crude oil to a decrease in pressure, preferably in the range of from 5 to 100 bar, more preferably from 10 to 50 bar.

12. A method for evaluating the activity of an anti-foam agent in a liquid, wherein the individual lifetime of a gas bubble in the liquid is measured using a method according to claim 6, and the liquid in the sample cell comprises an anti-foam agent.
